(19) United States
(12) Patent Application Publication
(10) Pub. No.: US 2003/0086560 A1
(43) Pub. Date: May 8, 2003

(54) Electrical static discharge (ESD) protection circuit for modems

(76) Inventors: Robert Alan Pitsch, Carmel, IN (US); Raymond Saksa, Brownsburg, IN (US)

Correspondence Address: JOSEPH S. TRIPOLI, THOMSON MULTIMEDIA LICENSING INC., 2 INDEPENDENCE WAY, P.O. BOX 5312, PRINCETON, NJ, 08543-5312, US

(21) Appl. No.: 10/007,864

(22) Filed: Nov. 8, 2001

(51) Int. Cl. H04M 1/00; H04M 9/00

(52) U.S. Cl. 379/412

(57) ABSTRACT

An electrical static discharge (ESD) protection circuit that protects a modem or electronic equipment employing the modem from lockup or malfunction caused by ESD at the secondary winding of a modem transformer as ESD passes from an RJ-11 interface to the transformer. The ESD protection circuit comprises two zener diodes to detect ESD passing through the secondary winding, wherein a ground leg is coupled to a chassis ground and to a ground plane of a PC board via a low impedance connection to the at least one coupling for grounding one side of the zener diodes to divert the detected ESD to the chassis ground.

### FIELD OF THE INVENTION

This invention relates to protection circuits, and more particularly to an electrical static discharge (ESD) protection circuit for modems and electronic equipment employing modems.

### BACKGROUND OF THE INVENTION

Electrical static discharge (ESD) has been known to lockup or damage integrated circuits (ICs) of modems and electronic equipment employing modems that are coupled to a conventional telephone line. For example, electrical static can buildup on a person's body as they walk across carpet in a relatively dry (low humidity) environment commonplace in a residence or office building. When plugging a conventional RJ-11 plug into an RJ-11 wall jack, the electrical static buildup, which can range up to 20 KV, can be automatically discharged from the person's body to the electrical connection created by the RJ-11 plug and jack. Thereafter, the ESD finds a path and typically travels into the modem or electronic equipment causing ICs to lockup or malfunction. In most instances, the lockup or malfunction can be easily remedied by resetting or disconnecting power and then reconnecting the modem or equipment to reinitialize the ICs. Nevertheless, more severe damage may occur, which cannot be easily remedied by turning on and off the modem or equipment.

Moreover, electrical static can buildup between the Tip and Ring of the RJ-11 jack of the wall from electric static charge buildup through air-draped telephone wires or cables. In such cases, electric static charge may be transferred to the ICs when the electrical connection is completed upon plugging in the RJ-11 plug into the RJ-11 wall jack, thereby causing a lockup or malfunction.

Additionally, installed modems or electronic equipment can experience a lockup condition or malfunction as the result of electric static charge flowing along the telephone wires or cables, such as without limitation, when a field technician discharges electrical static carried by their body onto the telephone wires or cables. The ESD travels along the telephone wire or cables to the RJ-11 jack at the wall of a nearby residence or office building. The electrical connection of the RJ-11 plug and jack provides a path to allow the ESD to flow to the IC circuitry on a printed-circuit (PC) board of the modem or the electronic equipment.

Most modem designs rely on two high-voltage capacitors (one from Tip to ground, the other from Ring to ground) in an attempt to divert ESD away from the ICs of a PC board. This method has two main disadvantages. One disadvantage is that the use of these two capacitors, unless closely matched in value, will tend to allow a 60 Hz hum to be injected in the modem, which affects the modem's performance. The other disadvantage is that these capacitors do not protect against any ESD that passes through the modem transformer from the primary side to the secondary side, thus exposing the modem or other ICs to voltages above integrated circuit (IC) maximums, which can cause lockup conditions or malfunction in such ICs. It is an object of the present invention to provide a protection circuit that overcomes these drawbacks.

### SUMMARY OF THE INVENTION

An electrical static discharge (ESD) protection circuit for use with modems or equipment employing modems which includes two zener diodes coupled to first and second terminals, respectively, of a secondary winding of a modem or telco transformer for detecting ESD. The protection circuit may include a ground leg or tab coupled to a chassis ground and to the ground plane of the PC board via a low impedance path to a grounding location of the zener diodes to divert the detected ESD to the chassis ground instead of the PC board's ground plane.

### BRIEF DESCRIPTION OF THE DRAWINGS

FIG. 1 shows a schematic/block diagram of an exemplary embodiment of the ESD protection circuit in combination with a modem of an integrated receiver decoder (IRD) according to the present invention.

FIG. 2 shows a partial cross-sectional view of the chassis and printed-circuit (PC) board according to the present invention.

### DETAILED DESCRIPTION OF THE INVENTION

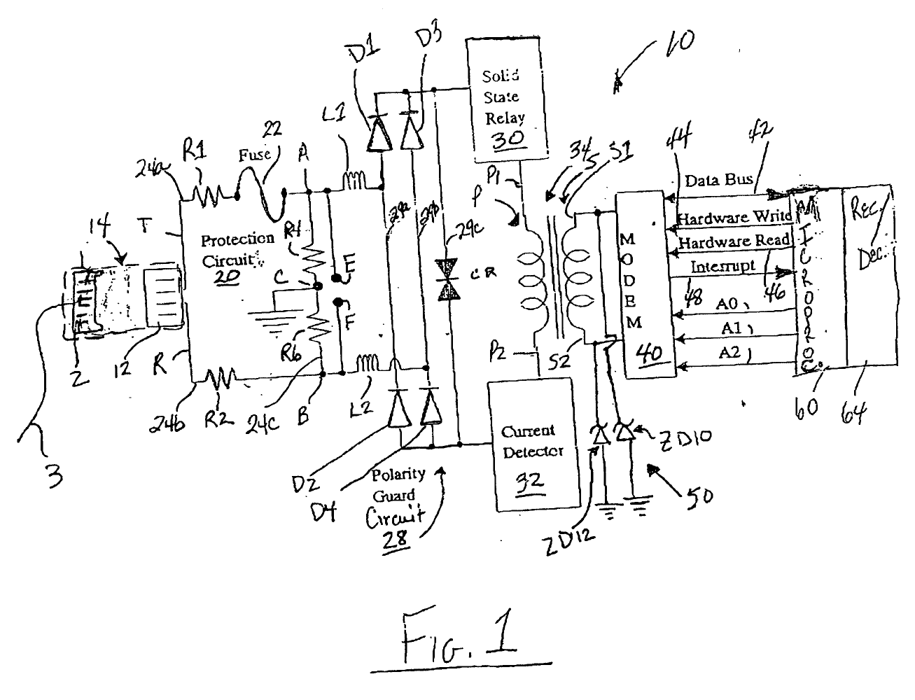

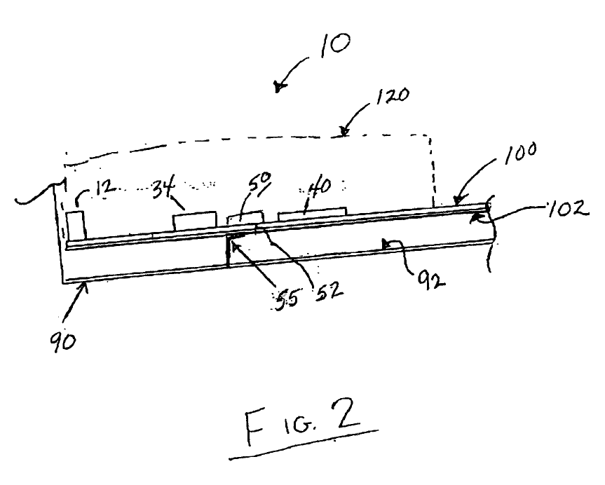

Referring now to FIGS. 1 and 2, the ESD protection circuit 50 of the present invention will be described in relation to the printed-circuit (PC) board 100 shown in FIG. 2. It should be noted that the view of the PC board 100 and integrated circuits 120 and other circuit components thereon are shown in block form only for simplicity of description of the inventive concepts herein. The PC board 100 includes the integrated circuits (ICs) 120 of the Integrated Receiver Decoder (IRD) 10 and a ground plane 102. The PC board 100 is housed in chassis 90. The ESD protection circuit 50 includes two zener diodes ZD10 and ZD12 coupled both to the first and second terminals S1 and S2, respectively, of the secondary winding S of transformer 34 and to ground (as shown in FIG. 1), provided by at least one ground coupling 52 to at least one location on the PC board's ground plane 102.

The ESD protection circuit 50 further includes a ground tab 55, best seen in FIG. 2, coupled to both the ground 92 of the chassis 90 and via a low impedance connection to the at least one location on the ground plane 102 which grounds one side of each of the zener diodes ZD10 and ZD12. This causes any ESD that has passed through the transformer 34 to the secondary winding S, such as from RJ-11 interface 14, to be diverted to the chassis ground 92 instead of passing through the PC board's ground plane 102 via the ground leg or ground tab 55. Hence, the modem 40 and other integrated circuits 120 of the IRD 10 are protected from ESD lockup or malfunction.

In operation, the zener diodes ZD10 and ZD12 are coupled directly to the first and second terminals S1 and S2, respectively, of the secondary winding S so that an ESD discharge greater than either a forward or reverse zener junction voltage can be clamped. Upon conduction, the zener diodes ZD10 and ZD12 conduct to pass the detected ESD to the chassis ground 92 via the ground tab 55, thereby enabling the ESD to flow along the path of least impedance.

Referring now to FIG. 1, the ESD protection circuit 50 is preferably used with modems or electronic equipment employing modems. In the exemplary embodiment of the present invention, the ESD protection circuit 50 is used with an integrated receiver decoder (IRD) of the present invention designated by the numeral 10. The IRD 10 is commonly referred to as a satellite receiver having a pay-per-view billing callback capability via modem 40. The IRD 10 includes a RJ-11 plug 12 for connection to a telephone line 3 via a RJ-11 jack 2. The combination RJ-11 plug 12 and RJ-11 jack 2 defines the RJ-11 interface 14. The RJ-11 plug 12 includes a tip T terminal and a ring terminal R coupled to a voltage and current protection circuit 20. The protection circuit 20 includes two parallel paths 24a and 24b one coupled to the tip terminal T and the other coupled to the ring terminal R.

The path 24a includes resistor R1 in series with fuse 22. Fuse 22 is in series with a first terminal of inductor L1. The path 24b includes resistor R2 coupled in series with a first terminal of inductor L2. Node A is coupled between fuse 22 and inductor L1. Node B is coupled between resistor R2 and the first terminal of inductor L2. Path 24c connects Node A and B together. Nodes A and B have coupled thereto the first terminals of resistors R4 and R6, respectively. The second terminals of resistors R4 and R6 are coupled together at Node C, which is coupled to ground. Adjacent to Node A and Node B but before the first terminal of inductors L1 and L2, respectively, is an open circuit path to terminals E and F wherein the open circuit path is generally parallel to the path between Nodes A and B.

Coupled to the voltage protection circuit 20 is a polarity guard circuit 28 wherein the second terminal of inductor L1 is coupled between an anode of diode D1 and a cathode of diode D2 of the polarity guard circuit 28. Likewise, the second terminal of inductor L2 is coupled between an anode of diode D3 and a cathode of diode D4 of the polarity guard circuit 28. The anodes of diodes D1 and D3 are in series with the cathodes of diodes D2 and D4, respectively. The diode pair of D1 and D2 on path 29a is in parallel with the diode pair of D3 and D4 on path 29b. Parallel paths 29a and 29b are in parallel with path 29c having crowbar protection device CR coupled therein. Parallel paths 29a, 29b and 29c of the polarity guard circuit 28 have one end coupled to a solid-state relay circuit 30 and the other end coupled to a current detector 32.

The solid-state relay circuit 30 is coupled to a first terminal P1 of the primary winding P of modem or teleco transformer 34. The current detector 32 is coupled to a second terminal P2 of the primary winding P of transformer 34. The second winding S of the modem or teleco transformer 34 is coupled to the modem 40.

Modem 40 is a conventional modem. Line or conductor 42 is a bidirectional data bus between modem 40 and microprocessor or controller 60 of the IRD 10. It should be noted that the microprocessor or controller 60 also functions to interface and control operations of receiver/decoder 64 of the IRD 10. Line or conductor 44 is a hardware write line from the microprocessor or controller 60. Line or conductor 46 is a hardware read line from the microprocessor or controller 60. Line 48 an interrupt line to the microprocessor or controller 60. Lines A0-A2 receive addressing from microprocessor or controller 60.

In operation, the modem 40 converts data for communication over a conventional telephone line 3 via a RJ-11 interface 14. The operation and details of modem 40 and the associated protection circuit 20, polarity guard circuit 28, solid-state relay circuit 30 and current detector 32 are exemplary and can vary in design.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications which come within the scope of the appended claims is reserved.

What is claimed is:

1. An electrical static discharge (ESD) protection circuit, comprising:
two zener diodes which detect and pass ESD passing through a winding of a modem transformer, the two zener diodes being coupled to a ground plane via at least one coupling; and
a ground leg coupled to a chassis ground to divert the detected ESD to the chassis ground.

2. The protection circuit according to claim 1, wherein the modem transformer has a primary winding coupled to an RJ-11 interface, a secondary winding is coupled directly to the modem, and the two zener diodes are coupled between first and second terminals, respectively, of the secondary winding and the modem.

3. The protection circuit according to claim 2, wherein diverting the detected ESD prevents a lockup condition or malfunction of an integrated circuit of the modem after the ESD passes through the secondary winding from the RJ-11 interface.

4. The protection circuit according to claim 2, wherein diverting the detected ESD prevents a lockup condition or malfunction of an integrated circuit of an electronic apparatus after the ESD passes through the secondary winding from the RJ-11 interface.

5. The protection circuit according to claim 4, wherein the electronic apparatus further includes an integrated receiver decoder having a pay per view billing capability.

6. The protection circuit according to claim 4, wherein the electronic apparatus comprising a video receiver.

7. The protection circuit according to claim 1, wherein upon detection of the ESD, the two zener diodes conduct to pass the detected ESD to the ground plane, and the ground leg diverts the detected ESD passed to the ground plane directly to the chassis ground.

8. An electronic apparatus, comprising:
a chassis having a chassis ground;
a printed circuit board having a ground plane, a transformer and a modem coupled to a winding of the transformer; and
an electrical static discharge (ESD) protection circuit having means for detecting ESD passing through the winding of the teleco transformer and means for diverting the detected ESD to the chassis ground.

9. The apparatus according to claim 8, wherein the ESD detecting means includes two zener diodes coupled to first and second terminals of the winding of the transformer and to the ground plane via a ground coupling.

10. The apparatus according to claim 9, wherein the diverting means includes a ground leg coupled to the chassis ground and to the ground plane.

11. The apparatus of claim 9 wherein the winding is a secondary winding.

12. The apparatus according to claim 9, wherein the transformer has a primary winding coupled to an RJ-11 interface, the secondary winding is coupled directly to the modem, and the two zener diodes are coupled between the first and second terminals, respectively, of the secondary winding and the modem.

13. The apparatus according to claim 12, wherein diverting the detected ESD prevents a lockup condition or malfunction of an integrated circuit of the modem after the ESD passes through the secondary winding from the RJ-11 interface.

14. The apparatus according to claim 12, wherein diverting the detected ESD prevents a lockup condition or malfunction of an integrated circuit of an electronic device after the ESD passes through the secondary winding from the RJ-11 interface.

15. The protection circuit according to claim 14, further comprising an integrated receiver decoder with pay per view capability.

16. The protection circuit according to claim 14, further comprising a satellite receiver with pay per view capability.

17. A method for protecting a modem from electrical static discharge (ESD), comprising the steps of:
bypassing the ESD passing through a secondary winding of a modem transformer;
coupling the bypassed ESD at a location on a printed-circuit board's ground plane; and
diverting the bypassed ESD to a chassis ground having a low impedance connection via a ground leg.
